(19) United States
(12) Patent Application Publication
(10) Pub. No.: US 2017/0052366 A1
(43) Pub. Date: Feb. 23, 2017

(54) OPTICAL SCANNER, IMAGE DISPLAY DEVICE, AND HEAD MOUNTED DISPLAY

(71) Applicant: Seiko Epson Corporation, Tokyo (JP)

(72) Inventors: Yukihide YAMANO, Chino (JP); Yasushi MIZOGUCHI, Suwa (JP)

(21) Appl. No.: 15/234,456

(22) Filed: Aug. 11, 2016

(30) Foreign Application Priority Data
Aug. 18, 2015 (JP) 2015-160834

(51) Int. Cl. G02B 26/10; G02B 27/01; G02B 5/00

(52) U.S. Cl. CPC G02B 26/101; G02B 5/003; G02B 27/0172; G02B 27/0101; G02B 2027/0178

(57) ABSTRACT

An optical scanner includes a movable section, first shaft sections configured to support the movable section to be capable of swinging, a driving section configured to support the first shaft sections, second shaft sections configured to support the driving section to be capable of swinging, a supporting section configured to support the second shaft sections, and an elastic section having a modulus of elasticity lower than the modulus of elasticity of the second shaft sections. In plan view, the elastic section is fixed in a region different from a region on a first imaginary straight line of the supporting section and is in contact with the second shaft sections.

### BACKGROUND

1. Technical Field

The present invention relates to an optical scanner, an image display device, and a head mounted display.

2. Related Art

JP-A-7-230052 (Patent Literature 1) discloses an optical scanner that scans light. The optical scanner disclosed in Patent Literature 1 includes a movable section including a mirror surface and an elastic deformation section that supports the movable section. When the elastic deformation section is elastically deformed, the movable section swings. Consequently, light reflected on the mirror surface is scanned. The optical scanner disclosed in Patent Literature 1 includes a stopper (a displacement regulating section) that covers the elastic deformation section. Excessive deformation of the elastic deformation section is prevented by the stopper to reduce breakage of the optical scanner.

However, in the configuration disclosed in Patent Literature 1, the stopper has to be accurately disposed with respect to the elastic deformation section. The stopper cannot be easily disposed.

### SUMMARY

An advantage of some aspects of the invention is to provide an optical scanner, an image display device, and ahead mounted display in which a displacement regulating section can be easily disposed.

An optical scanner according to an aspect of the invention includes: a movable section; a shaft section configured to support the movable section to be capable of swinging around a swing axis; a supporting section configured to support the shaft section; and an elastic section having a modulus of elasticity lower than the modulus of elasticity of the shaft section. When a straight line crossing a connecting section of the shaft section and the supporting section and extending along the swing axis in a plan view of the movable section is set as a first imaginary straight line, the elastic section is fixed in a region different from a region on the first imaginary straight line of the supporting section and is in contact with the shaft section.

With this configuration, excessive displacement of the shaft section can be regulated by the elastic section. Therefore, it is possible to reduce breakage of the optical scanner (in particular, breakage and damage of the shaft section). Since the elastic section is disposed in contact with the shaft section, it is easy to dispose the elastic section compared with when the elastic section is disposed not in contact with the shaft section as in the past.

In the optical scanner according to the aspect of the invention, it is preferable that, when a straight line crossing the shaft section and orthogonal to the swing axis in the plan view of the movable section is set as a second imaginary straight line, the elastic section is fixed in a region on the second imaginary straight line of the supporting section.

With this configuration, it is possible to easily dispose the elastic section. For example, when the shaft section is fixed to the elastic section, it is possible to effectively reduce displacement of the shaft section in a direction extending along the second imaginary straight line.

In the optical scanner according to the aspect of the invention, it is preferable that the supporting section is provided to surround the movable section and the shaft section in the plan view of the movable section, the second imaginary straight line crosses the supporting section in two places, and the elastic section is fixed in regions of two places where the second imaginary straight line and the supporting section overlap.

With this configuration, it is possible to fix the elastic section to the supporting section in a stable state.

In the optical scanner according to the aspect of the invention, it is preferable that the elastic section is fixed to the supporting section in an extended state compared with a state before the elastic section is fixed to the supporting section.

With this configuration, a bend of the elastic section is reduced. It is possible to more effectively regulate excessive displacement of the shaft section. It is possible to easily align the shaft section and the elastic section according to a balance of elasticity.

In the optical scanner according to the aspect of the invention, it is preferable that the elastic section includes recessed sections, and the shaft section is located in the recessed sections.

With this configuration, it is possible to more effectively regulate excessive displacement of the shaft section.

In the optical scanner according to the aspect of the invention, it is preferable that the elastic section is fixed to the shaft section.

With this configuration, since sliding of the shaft section and the elastic section is prevented, it is possible to more effectively regulate excessive displacement of the shaft section.

In the optical scanner according to the aspect of the invention, it is preferable that the shaft section is sandwiched by the elastic sections in a plan view of the shaft section.

With this configuration, it is possible to effectively regulate displacement of the shaft section in the thickness direction.

In the optical scanner according to the aspect of the invention, it is preferable that the elastic section has alight absorption ratio higher than the light absorption ratio of the shaft section and the supporting section.

With this configuration, it is possible to suppress occurrence of stray light (light reflected on the shaft section and the supporting section) by covering the shaft section and the supporting section with the elastic section.

In the optical scanner according to the aspect of the invention, it is preferable that the elastic section includes silicone elastomer.

With this configuration, the configuration of the elastic section is simplified. It is possible to set the modulus of elasticity of the elastic section sufficiently small with respect to the modulus of elasticity of the shaft section.

In the optical scanner according to the aspect of the invention, it is preferable that the elastic section is fixed to the supporting section by activated joining.

With this configuration, it is possible to increase joining strength of the elastic section and the supporting section.

An image display device according to another aspect of the invention includes the optical scanner according to the aspect of the invention.

With this configuration, it is possible to obtain the image display device having high reliability.

A head mounted display according to still another aspect of the invention includes: the optical scanner according to the aspect of the invention; and a frame mounted with the optical scanner and worn on the head of an observer.

With this configuration, it is possible to obtain the head mounted display having high reliability.

### BRIEF DESCRIPTION OF THE DRAWINGS

The invention will be described with reference to the accompanying drawings, wherein like numbers reference like elements.

FIG. 1 is a configuration diagram of an image display device according to a first embodiment of the invention.

FIG. 2 is a plan view (a top view) of an optical scanner included in the image display device shown in FIG. 1.

FIG. 3 is a sectional view taken along line A-A in FIG. 2.

FIG. 4 is a plan view (a top view) showing a displacement regulating section included in the optical scanner.

FIG. 5 is a plan view (a bottom view) showing the displacement regulating section included in the optical scanner.

FIG. 6 is a sectional view taken along line B-B in FIG. 4.

FIG. 7 is a sectional view taken along line C-C in FIG. 4.

FIG. 8 is a plan view (a top view) showing an optical scanner according to a second embodiment of the invention.

FIG. 9 is a sectional view showing an optical scanner according to a third embodiment of the invention.

FIG. 10 is a sectional view showing the optical scanner according to the third embodiment of the invention.

FIG. 11 is a plan view (a top view) showing an optical scanner according to a fourth embodiment.

FIG. 12 is a perspective view showing a head-up display applied with an image display device according to the invention.

FIG. 13 is a perspective view showing a head mounted display according to the invention.

### DESCRIPTION OF EXEMPLARY EMBODIMENTS

Preferred embodiments of an optical scanner, an image display device, and a head mounted display according to the invention are explained below with reference to the accompanying drawings.

### First Embodiment

First, an image display device according to a first embodiment of the invention is explained.

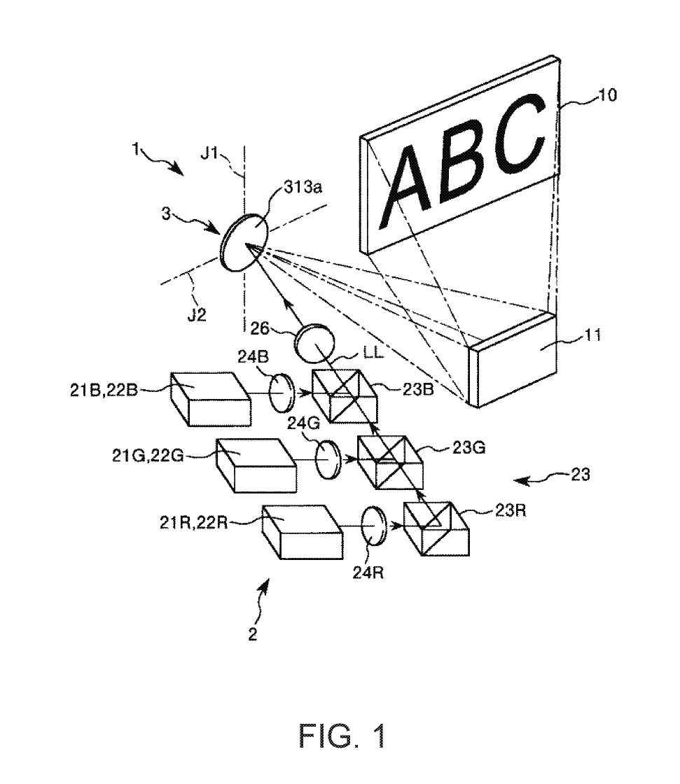

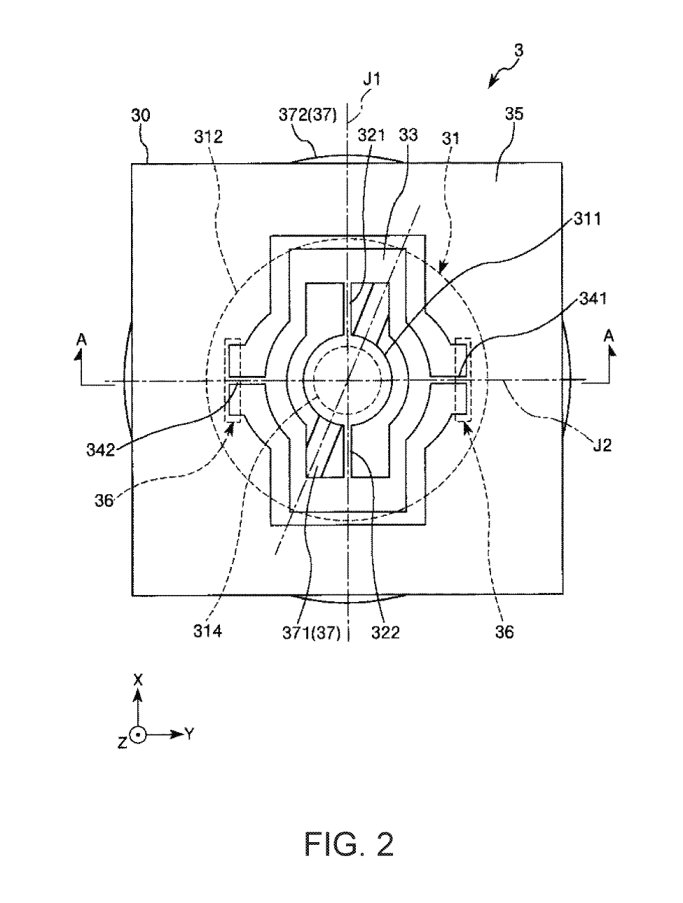

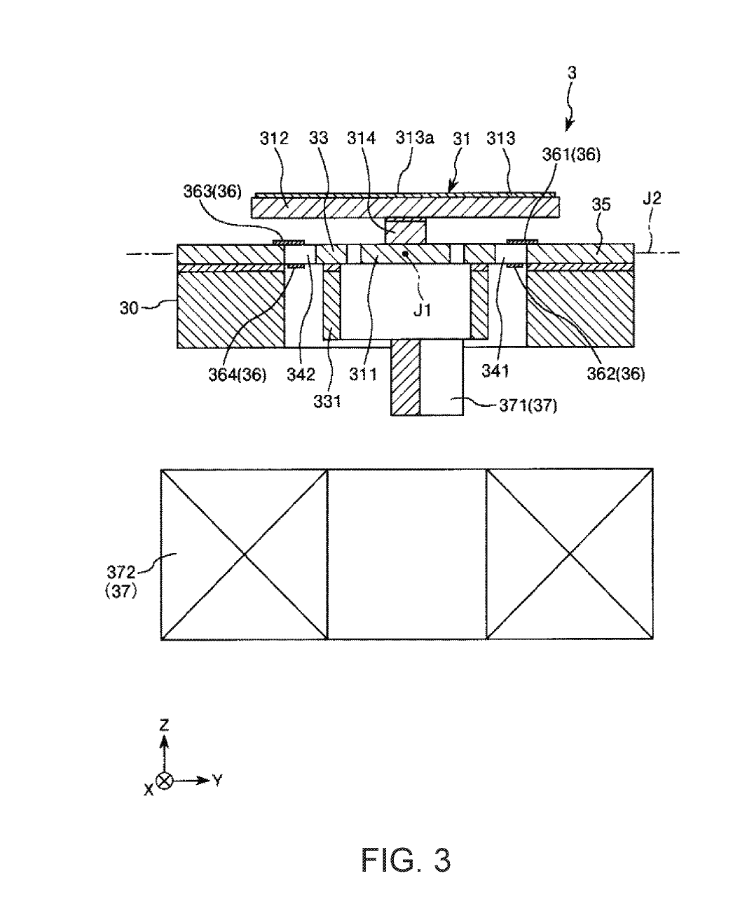

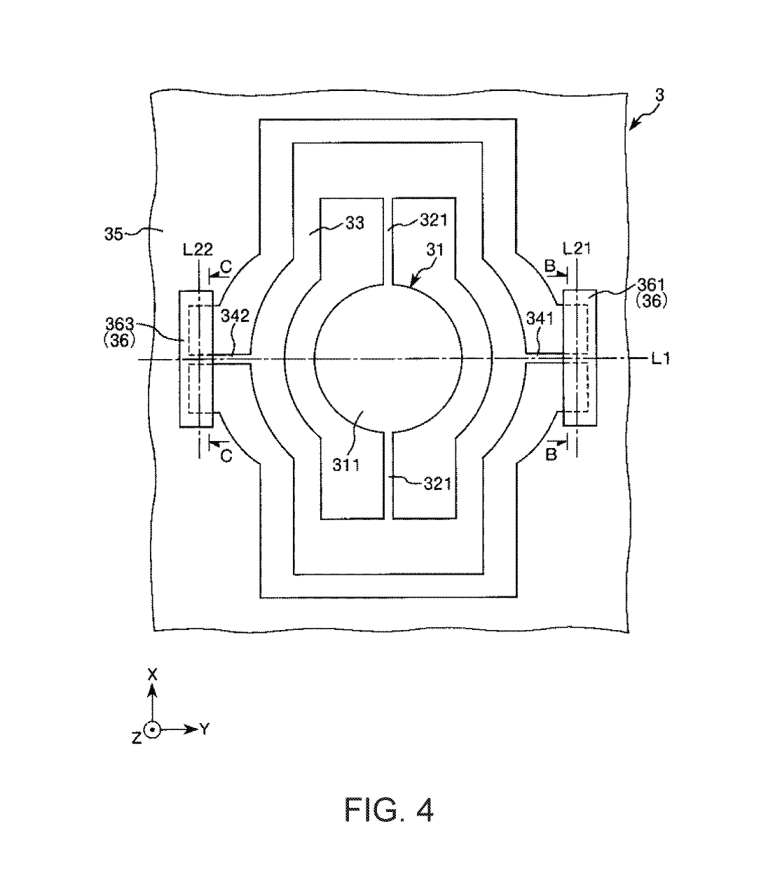

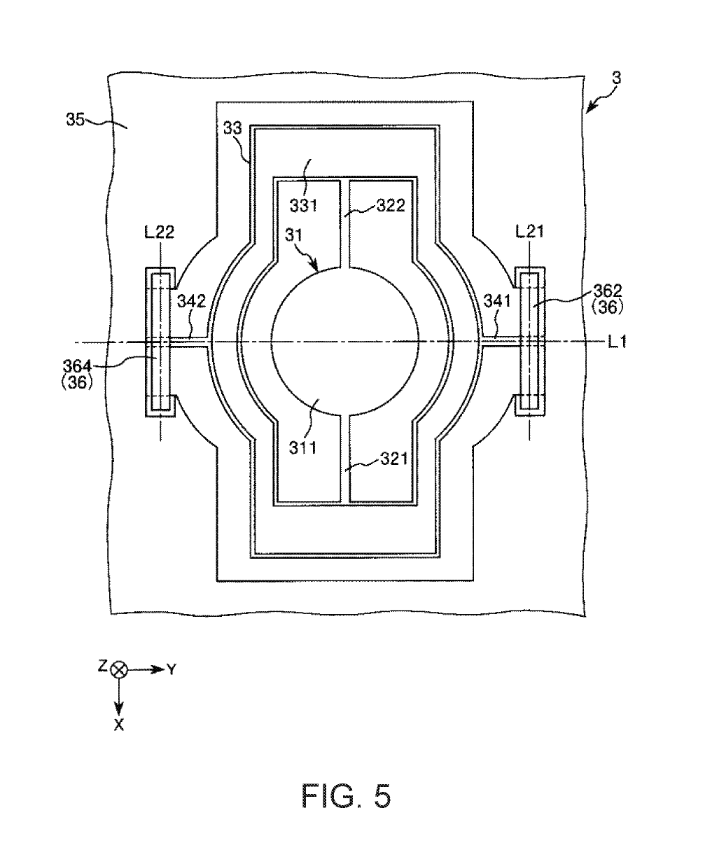

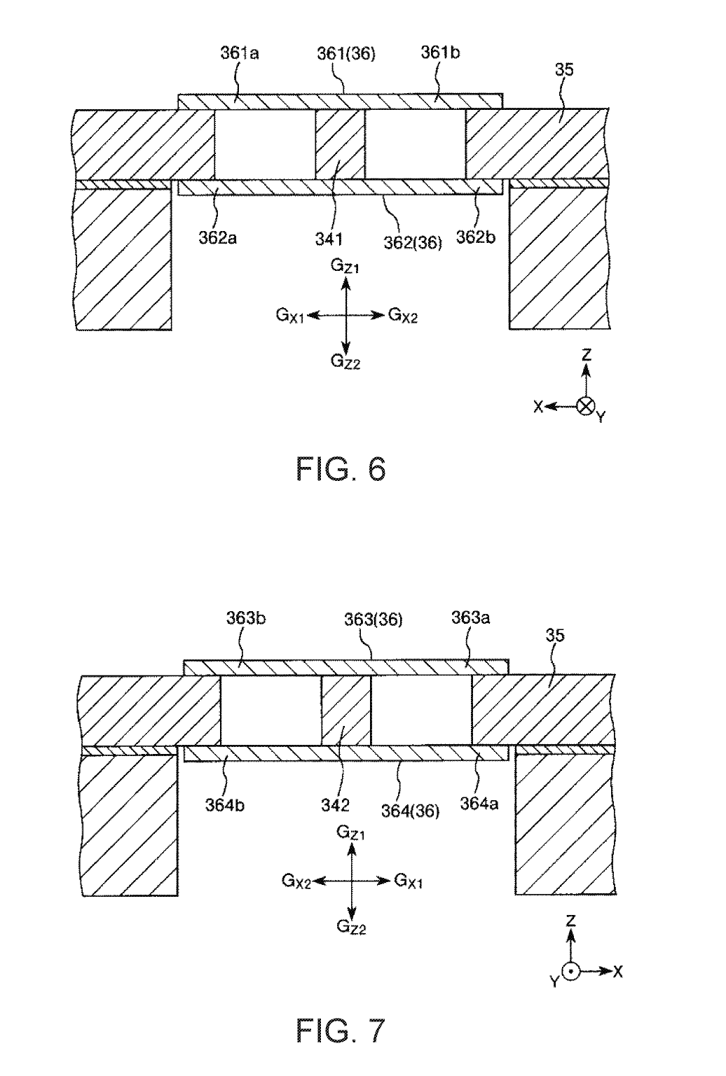

FIG. 1 is a configuration diagram of the image display device according to the first embodiment of the invention. FIG. 2 is a plan view (a top view) of an optical scanner included in the image display device shown in FIG. 1. FIG. 3 is a sectional view taken along line A-A in FIG. 2. FIG. 4 is a plan view (a top view) showing a displacement regulating section included in the optical scanner. FIG. 5 is a plan view (a bottom view) showing the displacement regulating section included in the optical scanner. FIG. 6 is a sectional view taken along line B-B in FIG. 4. FIG. 7 is a sectional view taken along line C-C in FIG. 4. Note that, in the following explanation, for convenience of explanation, the upper side in FIG. 2 is referred to as “upper” as well and a lower side in FIG. 2 is referred to as “lower” as well.

An image display device 1 shown in FIG. 1 is a device that two-dimensionally scans a laser LL for drawing on a target object 10 such as a screen or a wall surface to display an image. The image display device 1 includes a light source unit 2 that emits the laser LL for drawing and an optical scanner 3 that two-dimensionally scans the laser LL emitted from the light source unit 2. Note that, in the illustrated configuration, the laser LL scanned by the optical scanner 3 is reflected on a mirror 11 and irradiated on the target object 10. However, the mirror 11 may be omitted.

### Light Source Unit

The light source unit 2 includes, as shown in FIG. 1, a light source section including laser beam sources 21R, 21G, and 21B for respective colors of red, green, and blue, driving circuits 22R, 22G, and 22B that drive the laser beam sources 21R, 21G, and 21B, collimator lenses 24R, 24G, and 24B that collimate laser beams emitted from the laser beam sources 21R, 21G, and 21B, a light combining section 23, and a condensing lens 26.

The laser beam source 21R emits red light. The laser beam source 21G emits green light. The laser beam source 21B emits blue light. By using the three color lights, it is possible to display a full-color image. Note that the laser beam sources 21R, 21G, and 21B are not particularly limited. However, for example, a laser diode, an LED, and the like can be used.

The driving circuit 22R drives the laser beam source 21R. The driving circuit 22G drives the laser beam source 21G. The driving circuit 22B drives the laser beam source 21B. The driving by the driving circuits 22R, 22G, and 22B is independently controlled by a not-shown control section. The three laser beams emitted from the laser beam sources 21R, 21G, and 21B driven by the driving circuits 22R, 22G, and 22B are respectively collimated by the collimator lenses 24R, 24G, and 24B and made incident on the light combining section 23.

The light combining section 23 combines the lights from the laser beam sources 21R, 21G, and 21B. The light combining section 23 includes three dichroic mirrors 23R, 23G, and 23B. The dichroic mirror 23R has a function of reflecting the red light. The dichroic mirror 23G has a function of transmitting the red light and reflecting the green light. The dichroic mirror 23B has a function of transmitting the red light and the green light and reflecting the blue light.

Three-color laser beams of the red light, the green light, and the blue light from the laser beam sources 21R, 21G, and 21B can be combined using the dichroic mirrors 23R, 23G, and 23B. In this case, the intensities of the lights emitted from the laser beam sources 21R, 21G, and 21B are respectively independently modulated by the control section, whereby the laser LL (light) for drawing having a predetermined color is generated. After the numerical aperture of the laser LL generated in this way is changed to a desired NA (numerical aperture) by the condensing lens 26, the laser LL is led to the optical scanner 3.

The light source unit 2 is explained above. However, the configuration of the light source unit 2 is not limited to the configuration in this embodiment as long as the light source unit 2 can generate the laser LL.

### Optical Scanner

The optical scanner 3 includes, as shown in FIG. 1, a light reflection surface 313a capable of swinging around a first axis J1 and a second axis J2 orthogonal to (crossing) each other. The optical scanner 3 reflects the laser LL on the light reflection surface 313a to two-dimensionally scan the laser LL. The optical scanner 3 is explained in detail below. Note that, in the following explanation, a plan view viewed from the normal direction of the light reflection surface 313a in a stationary state is simply referred to as “plan view” as well.

The optical scanner 3 includes, as shown in FIG. 2, a structure 30 including a movable section 31, elastically deformable first shaft sections 321 and 322 that support the movable section 31 to be capable of swinging (turning) around the axis J1, a driving section (an outer-side swinging section) that supports the first shaft sections 321 and 322, elastically deformable second shaft sections 341 and 342 that support the driving section 33 to be capable of swinging (turning) around the second axis J2, and a supporting section 35 that supports the second shaft sections 341 and 342, a displacement regulating section 36 that regulates excessive displacement (displacement other than displacement involved in driving) of the movable section 31, and a driving section 37 that swings the movable section 31 around the first axis J1 and the second axis J2. Note that, in such a configuration, the “shaft section” described in the appended claims is configured from the first shaft sections 321 and 322, the driving section 33, and the second shaft sections 341 and 342.

The movable section 31 includes, as shown in FIGS. 2 and 3, abase section 311 supported by the first shaft sections 321 and 322, a holding section 312 disposed to be separated apart from the base section 311 in the upward direction, a light reflecting section 313 held by the holding section 312, and a coupling section 314 disposed between the base section 311 and the holding section 312 to couple the base section 311 and the holding section 312.

The holding section 312 is separated from the base section 311 and the first shaft sections 321 and 322 in the plate thickness direction and provided to overlap the entire region of the first shaft sections 321 and 322 and the second shaft sections 341 and 342. The light reflecting section 313 is provided on the upper surface of the holding section 312. The surface of the light reflecting section 313 is formed as the light reflection surface 313a that reflects the laser LL. That is, the laser LL is reflected on the light reflection surface 313a and scanned in a direction corresponding to the posture of the light reflection surface 313a. Note that the light reflecting section 313 can be formed of a metal film of aluminum or the like.

Since the holding section 312 is provided and the light reflecting section 313 is disposed in the holding section 312 in this way, it is possible to exhibit effects explained below. That is, with such a configuration, since it is unnecessary to provide the light reflecting section 313 in the base section 311, it is possible to reduce the base section 311 in size. Accordingly, it is possible to reduce the distance between the first shaft sections 321 and 322. Therefore, it is possible to reduce the optical scanner 3 in size. Since the holding section 312 shifts in the plate thickness direction with respect to the first shaft sections 321 and 322, the driving section 33, and the second shaft sections 341 and 342, it is possible to increase the holding section 312 in size without hindering the twisting deformation of the first shaft sections 321 and 322 and the second shaft sections 341 and 342 and a swing of the driving section 33. Therefore, it is possible to increase the light reflection surface 313a in size. Since the holding section 312 is provided in this way, it is possible to achieve a reduction in the size of the optical scanner 3 while increasing the light reflection surface 313a in size.

The first shaft sections 321 and 322 are disposed on opposite sides each other with respect to the base section 311. The first shaft sections 321 and 322 extend along the first axis J1. One end portions of the first shaft sections 321 and 322 are connected to the base section 311. The other end portions are connected to the driving section 33. The first shaft sections 321 and 322 support the movable section 31 to be capable of swinging around the first axis J1. The first shaft sections 321 and 322 are twisted and deformed according to a swing of the movable section 31 around the first axis J1. Note that the shape of the first shaft sections 321 and 322 is not particularly limited as long as the first shaft sections 321 and 322 can support the movable section 31 to be capable of swinging around the first axis J1.

The driving section 33 is formed in a frame shape and disposed to surround the base section 311 and the first shaft sections 321 and 322 in plan view. In other words, the base section 311 and the first shaft sections 321 and 322 are disposed on the inner side of the driving section 33. The driving section 33 is connected to the first shaft sections 321 and 322 and supports the first shaft sections 321 and 322. A rib 331 is provided on the lower surface of the driving section 33. A permanent magnet 371 is fixed to the lower surface of the rib 331. The rib 331 has a function of a reinforcing section that reinforces mechanical strength of the driving section 33 and a function of a gap material that secures, between the movable section 31 and the permanent magnet 371, a space for preventing contact of the movable section 31 and the permanent magnet 371.

The second shaft sections 341 and 342 are disposed on opposite sides each other with respect to the driving section 33. The second shaft sections 341 and 342 extend along the second axis J2. One end portions of the second shaft sections 341 and 342 are connected to the driving section 33. The other end portions are connected to the supporting section 35. The second shaft sections 341 and 342 support the driving section 33 to be capable of swinging around the second axis J2. The second shaft sections 341 and 342 are twisted and deformed according to a swing of the driving section 33 around the second axis J2. Note that the shape of the second shaft sections 341 and 342 is not particularly limited as long as the second shaft sections 341 and 342 can support the driving section 33 to be capable of swinging around the second axis J2.

The supporting section 35 is formed in a frame shape and disposed to surround the driving section 33 and the second shaft sections 341 and 342 in plan view. In other words, the driving section 33 and the second shaft sections 341 and 342 are disposed on the inner side of the supporting section 35. The supporting section 35 is connected to the second shaft sections 341 and 342 and supports the second shaft sections 341 and 342. The supporting section 35 is formed thicker than the movable section 31 and the driving section 33. Note that the shape of the supporting section 35 is not particularly limited. For example, a portion for supporting the second shaft section 341 and a portion for supporting the second shaft section 342 may be separated.

The structure 30 is explained above. In the structure 30, the base section 311, the first shaft sections 321 and 322, the driving section 33, the second shaft sections 341 and 342, and the supporting section 35 can be integrally formed by, for example, etching an SOI substrate [a substrate in which a first Si layer (a device layer), an SiO₂ layer (a box layer), and a second Si layer (a handle layer) are stacked in this order]. Specifically, the base section 311, the first shaft sections 321 and 322, and the second shaft sections 341 and 342 are formed from the device layer. The driving section 33 and the supporting section 35 are formed from the device layer, the box layer, and the handle layer. Consequently, it is possible to integrally form these sections. In the structure 30, the holding section 312 and the coupling section 314 can be integrally formed by, for example, etching the SOI substrate. Specifically, the holding section 312 is formed from the device layer. The coupling section 314 is formed from the box layer and the handle layer. Consequently, it is possible to integrally form these sections. However, a method of forming the structure 30 and the material of the structure 30 are not limited to this.

The driving section 37 includes, as shown in FIG. 3, the permanent magnet 371 provided on the lower surface of the rib 331 and a coil 372 disposed to be opposed to the permanent magnet 371 to generate a magnetic field acting on the permanent magnet 371. The permanent magnet 371 is formed in a bar shape disposed to incline with respect to the first axis J1 and the second axis J2 in plan view. One side of the permanent magnet 371 is an S pole and the other side is an N pole. As the permanent magnet 371, for example, a neodymium magnet, a ferrite magnet, a samarium cobalt magnet, an alnico magnet, and a bond magnet can be suitably used.

The driving section 37 is configured to apply, to the coil 372, a driving voltage obtained by superimposing a first voltage (e.g., an alternating voltage of approximately 15 kHz) for swinging the movable section 31 around the first axis J1 and a second voltage (e.g., an alternating voltage of approximately 60 Hz) for swinging the driving section 33 around the second axis J2. When the driving voltage is applied to the coil 372, a magnetic field corresponding to the driving voltage is generated in the coil 372. When the magnetic field acts on the permanent magnet 371, the movable section 31 (the light reflection surface 313a) swings around the first axis J1 and the second axis J2. Note that, in the optical scanner 3, it is desirable that the movable section 31 is swung by resonant driving and the driving section 33 is swung by non-resonant driving.

The displacement regulating section 36 is explained in detail. Note that, in the following explanation, for convenience of explanation, two axes orthogonal to each other in plan view are represented as an X axis and a Y axis and an axis orthogonal to the X axis and the Y axis is represented as a Z axis. The X axis extends along the first axis J1, the Y axis extends along the second axis J2, and the Z axis extends along the thickness direction of the movable section 31.

The displacement regulating section 36 has a function of suppressing excessive deformation of the second shaft sections 341 and 342 involved in excessive displacement of the movable section 31 with respect to the supporting section 35 at the time when a shock (acceleration in an in-XY plane direction and acceleration in the Z-axis direction) is applied to the optical scanner 3 by a drop or the like. By providing the displacement regulating section 36, it is possible to suppress damage (breakage and rupture) of the second shaft sections 341 and 342. The mechanical strength (shock resistance) of the optical scanner 3 is improved.

The displacement regulating section 36 includes, as shown in FIGS. 4 to 7, elastic sections 361 and 362 fixed to the supporting section 35 and disposed to sandwich the second shaft section 341 from upper and lower directions (both sides in the Z-axis direction) and elastic sections 363 and 364 fixed to the supporting section 35 and disposed to sandwich the second shaft section 342 from upper and lower directions. In other words, the second shaft section 341 is sandwiched by the elastic section 361 and the elastic section 362. The second shaft section 342 is sandwiched by the elastic section 363 and the elastic section 364. Further, the elastic section 361, the second shaft section 341, and the elastic section 362 are disposed in the Z-axis direction in this order in a sectional view of the second shaft section 341. The elastic section 363, the second shaft section 342, and the elastic section 364 are disposed in the Z-axis direction in this order in a sectional view of the second shaft section 342. Note that the elastic sections 361, 362, 363, and 364 may be disposed to sandwich surfaces crossing XY planes of the second shaft sections 341 and 342. The elastic sections 361, 362, 363, and 364 have elasticity (flexibility).

The elastic sections 361, 362, 363, and 364 are formed in a sheet shape (a belt shape) extending in the X-axis direction. The elastic sections 361, 362, 363, and 364 are fixed to the supporting section 35 at both end portions (both sides in the X-axis direction across the second shaft sections 341 and 342) and fixed to the second shaft sections 341 and 342 in the center. The elastic sections 361, 362, 363, and 364 may be in contact with the shaft section 341 and 342. That is, in plan view, when an imaginary straight line (a first imaginary straight line) L1 extending along the second axis J2, which it a swing axis of the second shaft sections 341 and 342, is set, the elastic sections 361, 362, 363, and 364 are fixed in a region different from a region on the first imaginary straight line L1 of the supporting section 35. Note that the first imaginary straight line L1 is desirably a straight line overlapping the second axis J2. The region on the first imaginary straight line L1 indicates a region obtained by projecting a region of passage of the first imaginary straight line L1 in the supporting section 35 onto the surface of the supporting section 35 from the thickness direction of the supporting section 35.

More specifically, in plan view, when an imaginary straight line (a second imaginary straight line) L21 crossing the second shaft section 341 and orthogonal to the second axis J2, which is a swing axis of the second shaft section 341, (i.e., extending along the X-axis direction) is set, the elastic sections 361 and 362 are fixed to a region on the imaginary straight line L21 of the supporting section 35. When an imaginary straight line (a second imaginary straight line) L22 crossing the second shaft section 342 and orthogonal to the second axis J2, which is a swing axis of the second shaft section 342, is set, the elastic sections 363 and 364 are fixed to a region on the imaginary straight line L22 of the supporting section 35. Note that the imaginary straight line L21 is desirably defined within an XY plane including the second axis J2. The regions on the imaginary straight lines L21 and L22 indicate regions obtained by projecting regions of passage of the imaginary straight lines L21 and L22 in the supporting section 35 onto the surface of the supporting section 35 from the thickness direction of the supporting section 35.

With the displacement regulating section 36, even if acceleration (a shock) in the X-axis direction is applied to the optical scanner 3, displacement in the X-axis direction of the second shaft sections 341 and 342 is regulated by the elastic sections 361, 362, 363, and 364. Specifically, when acceleration G_{X1} in a +X-axis direction is applied, portions 361a, 362a, 363a, and 364a of the elastic sections 361, 362, 363, and 364 further on a +X-axis side than the second shaft sections 341 and 342 act as supports to regulate displacement to a −X-axis side of the second shaft sections 341 and 342. Conversely, when acceleration G_{X2} in a −X-axis direction is applied, portions 361b, 362b, 363b, and 364b of the elastic sections 361, 362, 363, and 364 further on the −X-axis side than the second shaft sections 341 and 342 act as supports to regulate displacement to the +X-axis side of the second shaft sections 341 and 342.

Even if acceleration in the Z-axis direction is applied, displacement in the Z-axis direction of the second shaft sections 341 and 342 is regulated by the elastic sections 361, 362, 363, and 364. Specifically, when acceleration G_{Z1} in a +Z-axis direction is applied, the elastic sections 361 and 363 act as walls to regulate displacement to the −Z-axis side of the second shaft sections 341 and 342. Conversely, when acceleration G_{Z2} in a −Z-axis direction is applied, the elastic sections 362 and 364 act as walls to regulate displacement to the +Z-axis side of the second shaft sections 341 and 342.

As explained above, breakage due to excessive displacement of the second shaft sections 341 and 342 is suppressed by providing the displacement regulating section 36. Therefore, the optical scanner 3 has high mechanical strength (shock resistance). Therefore, the image display device 1 including the optical scanner 3 can exhibit high reliability. Since the elastic sections 361, 362, 363, and 364 are disposed in contact with the second shaft sections 341 and 342, it is easy to dispose the elastic sections 361, 362, 363, and 364 compared with when the elastic sections 361, 362, 363, and 364 are disposed not in contact with the second shaft sections 341 and 342 as in the past.

In particular, since the elastic sections 361, 362, 363, and 364 have elasticity, when the accelerations G_{X1}, G_{X2}, G_{Z1}, and G_{Z2} are applied, the elastic sections 361, 362, 363, and 364 are slightly expanded or contracted (elastically deformed) to slightly allow displacement of the second shaft sections 341 and 342. Therefore, it is possible to moderately allow stress at the time of the application of the accelerations G_{X1}, G_{X2}, G_{Z1}, and G_{Z2} to escape from the second shaft sections 341 and 342. It is possible to suppress accumulation of stress (fatigue) in the second shaft sections 341 and 342.

The elastic sections 361, 362, 363, and 364 are made of a material having a sufficiently small modulus of elasticity (Young's modulus) compared with the second shaft sections 341 and 342. Consequently, the elastic sections 361, 362, 363, and 364 do not substantially affect twisting deformation (deformation during driving) of the second shaft sections 341 and 342. It is possible to suppress deterioration in a driving characteristic of the optical scanner 3.

Note that the modulus of elasticity of the elastic sections 361, 362, 363, and 364 is desirably low as long as the displacement regulating section 36 can exhibit the function thereof. Specifically, for example, the Young's modulus of the elastic sections 361, 362, 363, and 364 is desirably 1/1000 or less, more desirably 1/10000 or less, and still more desirably 1/100000 or less of the Young's modulus of the second shaft sections 341 and 342. Consequently, the effects explained above become more conspicuous.

The elastic sections 361, 362, 363, and 364 are not particularly limited as long as the elastic sections 361, 362, 363, and 364 have elasticity. For example, various resin materials can be used. Among the resin materials, it is desirable to use silicone elastomer such as PDMS (Polydimethylsiloxane). Consequently, the elastic sections 361, 362, 363, and 364 are sufficiently soft with respect to the second shaft sections 341 and 342. Note that various softeners, hardeners, and the like may be included in the resin materials (in particular, silicone elastomer). The resin materials, the softeners, and the hardeners can be combined according to a driving characteristic of the optical scanner 3. Therefore, even if a ratio of the resin materials is smaller than a ratio of the softeners and the hardeners, the resin materials can be used as the elastic sections 361, 362, 363, and 364 if a characteristic of the resin materials having elasticity can be manifested. Incidentally, the Young's modulus of Si, which is the material of the second shaft sections 341 and 342, is approximately 180 GPa. The Young's modulus of the PDMS is approximately 1.5 MPa.

Further, by using the silicone elastomer as the elastic sections 361, 362, 363, and 364, the elastic sections 361, 362, 363, and 364 can be joined to the second shaft sections 341 and 342 and the supporting section 35, which are made of silicon (Si), by activated joining (direct joining). Therefore, it is possible to further increase joining strength of the elastic sections 361, 362, 363, and 364 and the second shaft sections 341 and 342 and the supporting section 35. Note that the activated joining means that the surface of the silicon (the second shaft sections 341 and 342 and the supporting section 35) is activated by plasma irradiation and the elastic sections 361, 362, 363, and 364 are stuck together in this state to bond the elastic sections 361, 362, 363, and 364 with covalent bonding of (—Si—O—Si—). Note that, when such activated joining cannot be used, the elastic sections 361, 362, 363, and 364 may be fixed using an adhesive or the like. When the elastic sections 361, 362, 363, and 364 has tackiness or adhesion, the elastic sections 361, 362, 363, and 364 may be fixed using the tackiness or the adhesion. Note that the fixing means a state of bonding by the covalent bonding, a state of gluing by an adhesive, or a state of sticking and adhering by the tackiness or the adhesion of the elastic sections 361, 362, 363, and 364.

The elastic sections 361, 362, 363, and 364 (in particular, the elastic sections 361 and 363 located on the upper surface side (a side on which the laser LL is made incident)) are desirably colored in, for example, black and have a higher absorption ratio of the laser LL (i.e., less easily reflect the laser LL) than the second shaft sections 341 and 342 and the supporting section 35. By covering at least a part of the structure 30 with the elastic sections 361, 362, 363, and 364, it is possible to suppress occurrence of stray light. “Have a higher absorption ratio” means that an absorption ratio of at least one of the red light, the green light, and the blue light included in the laser LL is high.

Note that the color of the elastic sections 361, 362, 363, and 364 is not limited to black as long as the absorption ratio of the laser LL is higher than the absorption ratio in the second shaft sections 341 and 342 and the supporting section 35. For example, by dispersing particulates of pigment, dye, or the like for coloring in the resin, which is the main material of the elastic sections 361, 362, 363, and 364, it is possible to relatively easily obtain the elastic sections 361, 362, 363, and 364 having a high light absorption ratio.

### Second Embodiment

An image display device according to a second embodiment of the invention is explained.

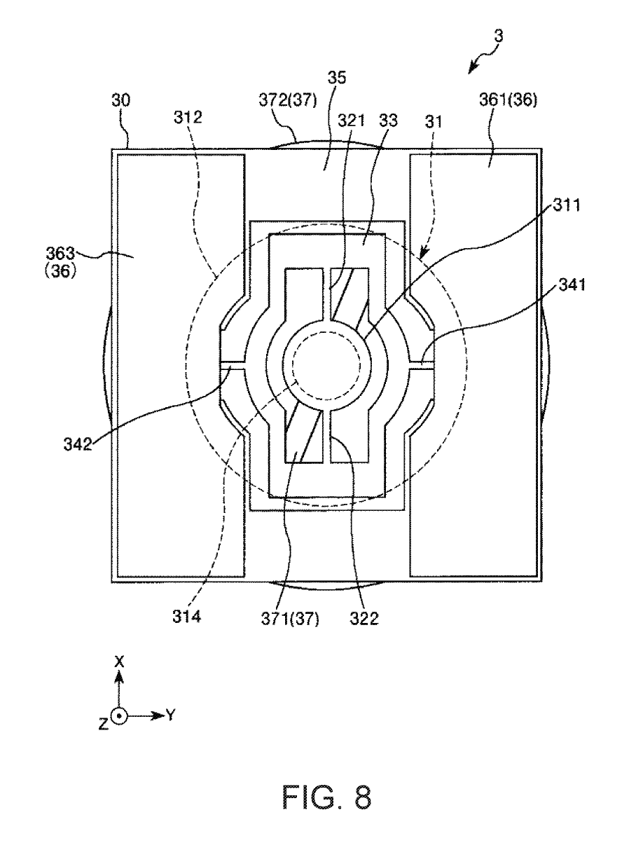

FIG. 8 is a plan view (a top view) showing an optical scanner according to the second embodiment of the invention.

Concerning the image display device according to the second embodiment, differences from the first embodiment are mainly explained. Explanation of similarities is omitted.

The image display device according to the second embodiment is the same as the image display device according to the first embodiment except that the configuration of the optical scanner (in particular, a displacement regulating section) is different. Note that components same as the components in the first embodiment are denoted by the same reference numerals.

In the optical scanner 3 shown in FIG. 8, the elastic sections 361 and 363 are formed larger than the elastic sections 361 and 363 in the first embodiment. The elastic sections 361 and 363 are provided to cover a wide range of the supporting section 35 in plan view. The elastic sections 361 and 362 project to the outer side from the outer circumference of the holding section 312 and are disposed to surround at least a part of the circumference of the holding section 312 in plan view. By disposing the elastic sections 361 and 363 in this way, it is possible to effectively suppress reflection of the laser LL in the supporting section 35. It is possible to more effectively suppress occurrence of stray light.

### Third Embodiment

An image display device according to a third embodiment of the invention is explained.

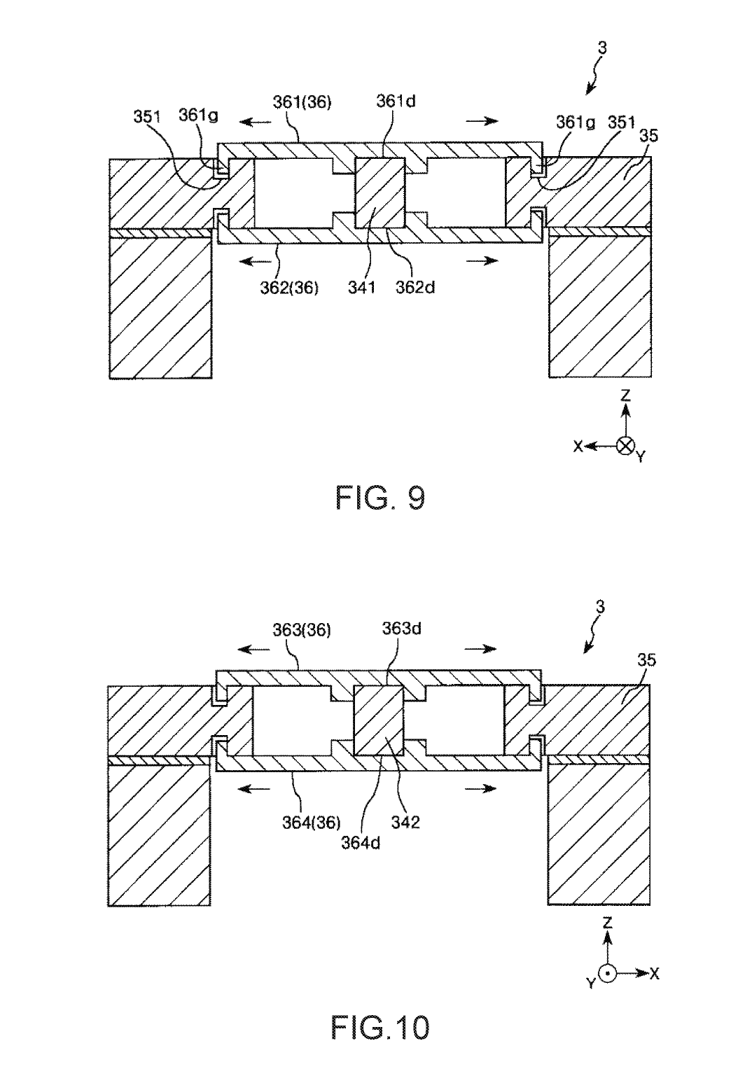

FIGS. 9 and 10 are respectively sectional views showing an optical scanner according to the third embodiment of the invention.

Concerning the image display device according to the third embodiment, differences from the embodiments explained above are mainly explained. Explanation of similarities is omitted.

The image display device according to the third embodiment of the invention is the same as the image display device according to the first embodiment except that the configuration of the optical scanner (in particular, a displacement regulating section) is different. Note that components same as the components in the embodiments are denoted by the same reference numerals.

In the optical scanner 3 shown in FIGS. 9 and 10, the elastic sections 361, 362, 363, and 364 included in the displacement regulating section 36 are fixed to the supporting section 35 in a state in which the elastic sections 361, 362, 363, and 364 are further extended in the X-axis direction than in a natural state (a state before the elastic sections 361, 362, 363, and 364 are fixed to the supporting section 35 (a state in which the elastic sections 361, 362, 363, and 364 are not fixed to the supporting section 35)). By fixing the elastic sections 361, 362, 363, and 364 to the supporting section 35 in the extended state in this way, it is possible to suppress a bend of the elastic sections 361, 362, 363, and 364. Therefore, the elastic sections 361, 362, 363, and 364 can more effectively regulate displacement (deformation other than twisting deformation) of the second shaft sections 341 and 342. Note that a degree of the extension of the elastic sections 361, 362, 363, and 364 is not particularly limited. However, for example, when length in the natural state is represented as L1 and length in the state in which the elastic sections 361, 362, 363, and 364 are fixed to the supporting section 35 is represented as L2, the length L2 desirably satisfies a range of 1.1L1≦L2≦2.0L1. When such a range is satisfied, the effects explained above become conspicuous. As an extending direction, besides the X-axis direction, in a state in which the elastic sections 361, 362, 363, and 364 are fixed in two places of the supporting section 35, the elastic sections 361, 362, 363, and 364 may be extended in a direction connecting the two places. Further, when the elastic sections 361, 362, 363, and 364 are fixed to the supporting section 35 and one of the second shaft sections 341 and 342, the elastic sections 361, 362, 363, and 364 may be extended in a direction connecting a portion fixed in the supporting section 35 and a portion fixed to one of the second shaft sections 341 and 342. Note that the extending direction can be applied to embodiments explained below.

Projecting sections 361g projecting to the lower side (the supporting section 35 side) are provided at both end portions of the elastic section 361. The projecting sections 361g engage (are caught) in recessed sections 351 formed in the supporting section 35, whereby the elastic section 361 is fixed to the supporting section 35. The elastic sections 362, 363, and 364 have the same configuration. In this way, the elastic sections 361, 362, 363, and 364 are physically caught in the supporting section 35. Therefore, it is possible to more surely fix the elastic sections 361, 362, 363, and 364 in the extended state to the supporting section 35. Note that an adhesive or the like may be used for the fixing of the elastic sections 361, 362, 363, and 364 to the supporting section 35.

A recessed section 361d is provided on the lower surface (a surface on the supporting section 35 side) of the elastic section 361. A recessed section 362d is provided on the upper surface (a surface on the supporting section 35 side) of the elastic section 362. The second shaft section 341 is located in the recessed sections 361d and 362d. Similarly, a recessed section 363d is provided on the lower surface of the elastic section 363 and a recessed section 364d is provided on the upper surface of the elastic section 364. The second shaft section 342 is located in the recessed sections 363d and 364d. Note that, in a state in which the second shaft sections 341 and 342 are located in the recessed sections 361d and 362d and the recessed sections 363d and 364d, the second shaft sections 341 and 342 may be in contact in the recessed sections 361d and 362d and the recessed sections 363d and 364d or the second shaft sections 341 and 342 may be disposed to be spaced apart from the wall surfaces of the recessed sections 361d and 362d and the recessed sections 363d and 364d. The second shaft section 341 only has to be located in one of the recessed sections 361d and 362d. The second shaft section 342 only has to be located in one of the recessed sections 363d and 364d.

With such a configuration, as in the first embodiment, it is possible to suppress excessive deformation of the second shaft sections 341 and 342 in the X-axis direction and the Z-axis direction. The optical scanner 3 has high mechanical strength (shock resistance).

In particular, in this embodiment, the elastic sections 361 and 362 are not fixed to the second shaft section 341 and are only in contact with the second shaft section 341. Similarly, the elastic sections 363 and 364 are not fixed to the second shaft section 342 and are only in contact with the second shaft section 342. Therefore, the second shaft section 341 is capable of sliding in the Y-axis direction with respect to the elastic sections 361 and 362. The second shaft section 342 is capable of sliding in the Y-axis direction with respect to the elastic sections 363 and 364. As a result, the elastic sections 361, 362, 363, and 364 much less easily affect twisting deformation of the second shaft sections 341 and 342. The optical scanner 3 has an excellent vibration characteristic. Note that the contact indicates, for example, a state in which the elastic sections 361 and 362 and the second shaft section 341 are slidably in contact or a state in which the elastic sections 361 and 362 and the second shaft section 341 are detachably disposed unlike a state in which elastic sections 361, 362, 363, and 364 are fixed.

The recessed sections 361d and 362d have a function of aligning the second shaft section 341. Similarly, the recessed sections 363d and 364d have a function of aligning the second shaft section 342. Specifically, as explained above, the elastic sections 361 and 362 are fixed to the supporting section 35 in the extended state. Therefore, the positions of the recessed sections 361d and 362d are maintained in places where the extension of the elastic sections 361 and 362 is balanced. Therefore, if the positions of the recessed sections 361d and 362d are designed in advance such that the second shaft section 341 is located in a correct position, the second shaft section 341 is aligned in the correct position by the recessed sections 361d and 362d. The same applied to the recessed sections 363d and 364d.

According to the third embodiment, it is possible to exhibit effects same as the effects in the first embodiment explained above.

### Fourth Embodiment

An image display device according to a fourth embodiment of the invention is explained.

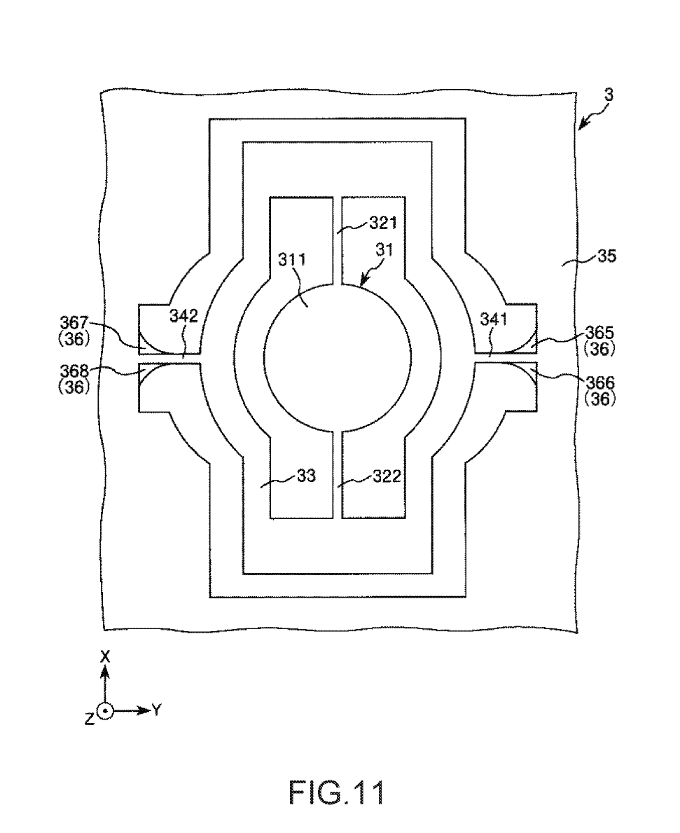

FIG. 11 is a plan view (a top view) showing an optical scanner according to the fourth embodiment of the invention.

Concerning the image display device according to the fourth embodiment, differences from the embodiments explained above are mainly explained. Explanation of similarities is omitted.

The image display device according to the fourth embodiment of the invention is the same as the image display device according to the first embodiment except that the configuration of the optical scanner (in particular, a displacement regulating section) is different. Note that components same as the components in the embodiments are denoted by the same reference numerals.

The displacement regulating section 36 of the optical scanner 3 shown in FIG. 11 includes elastic sections 365 and 366 that regulate displacement of the second shaft section 341 and elastic sections 367 and 368 that regulate displacement of the second shaft section 342. The elastic section 365 is fixed to one side surface of the second shaft section 341 and a side surface (an inner circumferential surface) of the supporting section 35. The elastic section 366 is fixed to the other side surface of the second shaft section 341 and a side surface (an inner circumferential surface) of the supporting section 35. The second shaft section 341 is sandwiched by the elastic sections 365 and 366 from the X-axis direction. The elastic section 367 is fixed to one side surface of the second shaft section 342 and a side surface (an inner circumferential surface) of the supporting section 35. The elastic section 368 is fixed to the other side surface of the second shaft section 342 and a side surface (an inner circumferential surface) of the supporting section 35. The second shaft section 342 is sandwiched by the elastic sections 367 and 368 from the X-axis direction.

Note that the elastic sections 365, 366, 367, and 368 are desirably gel-like. Consequently, it is possible to easily fix the elastic sections 365, 366, 367, and 368 to the second shaft sections 341 and 342 and the supporting section 35 making use of viscosity of the elastic sections 365, 366, 367, and 368. It is possible to relatively easily dispose the elastic sections 365, 366, 367, and 368 using, for example, a dispenser.

According to the fourth embodiment, it is possible to exhibit effects same as the effects in the first embodiment explained above.

### Fifth Embodiment

A head-up display according to a fifth embodiment of the invention is explained.

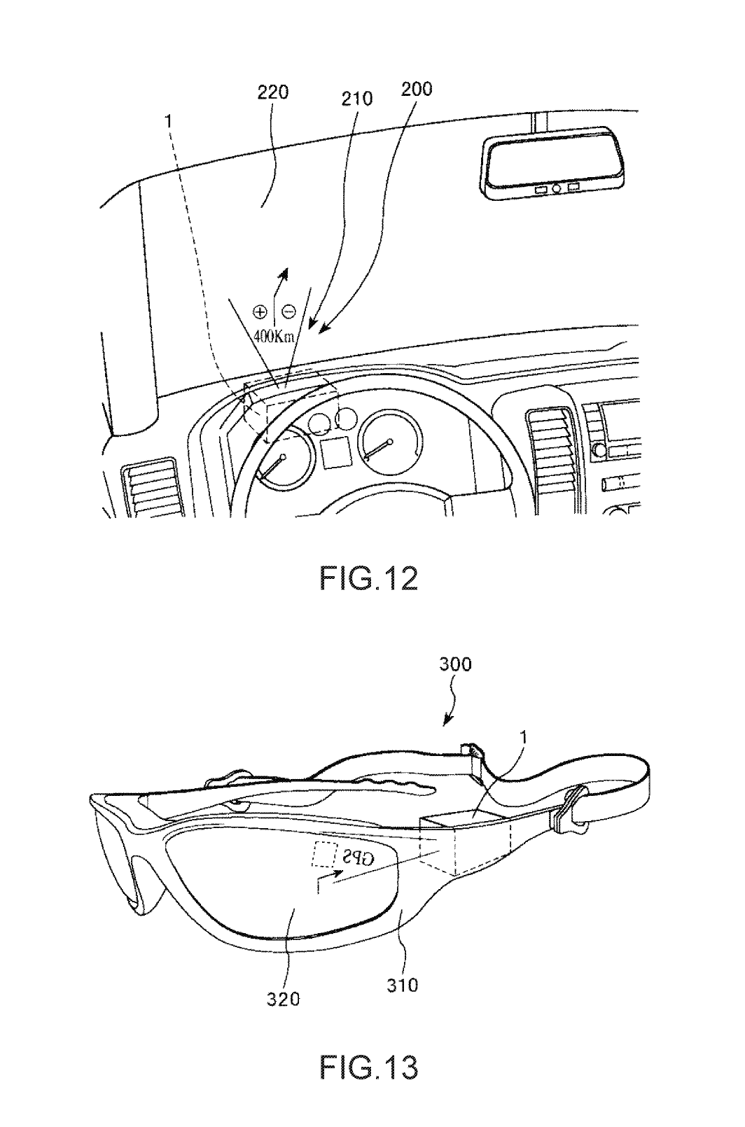

FIG. 12 is a perspective view showing a head-up display applied with an image display device according to the invention.

As shown in FIG. 12, in ahead-up display system 200, the image display device 1 is mounted on a dashboard of an automobile to configure a head-up display 210. Predetermined images of guide display to a destination, time, orientation, speed, outdoor temperature, weather, and the like can be displayed on a windshield 220 by the head-up display 210. Note that the head-up display system 200 can be applied to not only the automobile but also an airplane, a ship, and the like.

### Sixth Embodiment

A head mounted display according to a sixth embodiment of the invention is explained.

FIG. 13 is a perspective view showing a head mounted display according to the invention.

As shown in FIG. 13, a head mounted display 300 includes a frame 310 worn on the head of an observer and the image display device 1 mounted on the frame 310. A predetermined image visually recognized by one eye is displayed, by the image display device 1, on a display section (a light reflecting layer) 320 provided in a part, which is originally a lens, of the frame 310.

The display section 320 may be transparent or may be opaque. When the display section 320 is transparent, information from the image display device 1 can be superimposed on information (a scene) from the real world and used. The display section 320 only has to reflect at least a part of incident light. For example, a hologram element, a half mirror, and the like can be used in the display section 320.

The optical scanner, the image display device, and the head mounted display according to the invention are explained above on the basis of the embodiments shown in the figures. However, the invention is not limited to this. The components of the sections can be replaced with any components having the same functions. Any other components may be added to the invention.

In the embodiments, the configuration capable of two-dimensionally scanning a laser (around the first axis J1 and the second axis J2) is explained as the optical scanner. However, the configuration of the optical scanner is not limited to this. For example, the optical scanner may be configured to be capable of one-dimensionally scanning the laser. Specifically, for example, a configuration may be adopted in which the first shaft sections 321 and 322 and the driving section 33 are omitted from the configuration in the first embodiment and the second shaft sections 341 and 342 couple the movable section 31 and the supporting section 35. In this case, two optical scanners are prepared. The laser is scanned in the horizontal direction (a first direction) by one optical scanner and the laser is scanned in the vertical direction (a second direction crossing the first direction) by the other optical scanner. Consequently, it is possible to two-dimensionally scan the laser. In the embodiments, the configuration is explained in which the light reflecting section is provided in the holding section. However, a configuration may be adopted in which the holding section and the coupling section are omitted and the light reflecting section is provided in the base section.

The entire disclosure of Japanese Patent Application No. 2015-160834, filed Aug. 18, 2015 is expressly incorporated by reference herein.

What is claimed is:

1. An optical scanner comprising:
a movable section;
a shaft section configured to support the movable section to be capable of swinging around a swing axis;
a supporting section configured to support the shaft section; and
an elastic section having a modulus of elasticity lower than the modulus of elasticity of the shaft section, wherein
when a straight line crossing a connecting section of the shaft section and the supporting section and extending along the swing axis in a plan view of the movable section is set as a first imaginary straight line, the elastic section is fixed in a region different from a region on the first imaginary straight line of the supporting section and is in contact with the shaft section.

2. The optical scanner according to claim 1, wherein, when a straight line crossing the shaft section and orthogonal to the swing axis in the plan view of the movable section is set as a second imaginary straight line, the elastic section is fixed in a region on the second imaginary straight line of the supporting section.

3. The optical scanner according to claim 2, wherein
the supporting section is provided to surround the movable section and the shaft section in the plan view of the movable section,
the second imaginary straight line crosses the supporting section in two places, and
the elastic section is fixed in regions of two places where the second imaginary straight line and the supporting section overlap.

4. The optical scanner according to claim 1, wherein the elastic section is fixed to the supporting section in an extended state compared with a state before the elastic section is fixed to the supporting section.

5. The optical scanner according to claim 1, wherein the elastic section includes recessed sections, and the shaft section is located in the recessed sections.

6. The optical scanner according to claim 1, wherein the elastic section is fixed to the shaft section.

7. The optical scanner according to claim 1, wherein the shaft section is sandwiched by the elastic sections in a plan view of the shaft section.

8. The optical scanner according to claim 1, wherein the elastic section has a light absorption ratio higher than the light absorption ratio of the shaft section and the supporting section.

9. The optical scanner according to claim 1, wherein the elastic section includes silicone elastomer.

10. The optical scanner according to claim 1, wherein the elastic section is fixed to the supporting section by activated joining.

11. An image display device comprising the optical scanner according to claim 1.

12. An image display device comprising the optical scanner according to claim 2.

13. An image display device comprising the optical scanner according to claim 3.

14. An image display device comprising the optical scanner according to claim 4.

15. An image display device comprising the optical scanner according to claim 5.

16. A head mounted display comprising:
the optical scanner according to claim 1; and
a frame mounted with the optical scanner and worn on a head of an observer.

17. A head mounted display comprising:
the optical scanner according to claim 2; and
a frame mounted with the optical scanner and worn on a head of an observer.

18. A head mounted display comprising:
the optical scanner according to claim 3; and
a frame mounted with the optical scanner and worn on a head of an observer.

19. A head mounted display comprising:
the optical scanner according to claim 4; and
a frame mounted with the optical scanner and worn on a head of an observer.

20. A head mounted display comprising:
the optical scanner according to claim 5; and
a frame mounted with the optical scanner and worn on a head of an observer.
